(19) United States
(12) Patent Application Publication
(10) Pub. No.: US 2015/0098065 A1
(43) Pub. Date: Apr. 9, 2015

(54) LIGHT SOURCE DEVICE AND PROJECTION DISPLAY DEVICE

(71) Applicant: Panasonic Corporation, Osaka (JP)

(72) Inventor: Takaaki TANAKA, Osaka (JP)

(21) Appl. No.: 14/490,045

(22) Filed: Sep. 18, 2014

(30) Foreign Application Priority Data
Oct. 3, 2013 (JP) 2013-208006
Jun. 23, 2014 (JP) 2014-127972

(51) Int. Cl. G03B 21/20; F21V 14/08; F21K 99/00; G03B 21/00

(52) U.S. Cl. CPC G03B 21/204; G03B 21/008; F21V 14/08; F21K 9/56; G02B 26/008
USPC 353/84; 362/84

(57) ABSTRACT

A light source device includes a light source and a phosphor substrate. The phosphor substrate includes a substrate part, a first reflection film, a phosphor substance layer, and a second reflection film. The first reflection film is formed on a first place of the substrate part. The phosphor substance layer is formed on a surface opposite to the substrate part of the first reflection film, and emits fluorescence by light from the light source. The second reflection film is formed on a second place of the substrate part, and reflects the light from the light source. A surface of the phosphor substance layer on which the light from the light source is incident and a surface of the second reflection film from which the light from the light source is reflected are in substantially the same plane.

### BACKGROUND

1. Technical Field

The present disclosure relates to a light source device and a projection display device which irradiates an image formed by a light valve with light from the light source device and which enlarges and projects the image on a screen by a projection lens.

2. Background Art

As a light source of a projection display device using a light valve, for example, a digital micro-mirror device (DMD) or a liquid crystal panel, a discharge lamp is widely used. However, a lifetime of a discharge lamp is relatively short.

Thus, recently, projection display devices each using a light source such as a semiconductor laser and a light emitting diode, having a longer lifetime than a discharge lamp, have been developed. Such projection display devices use a light source device that collects light by using polarization property of light output from a light source.

FIG. 16 is a configuration diagram of conventional light source device 1. FIG. 17A is a top view of conventional phosphor substrate 11 (phosphor wheel). FIG. 17B is a sectional view taken on line 17B-17B of FIG. 17A. FIG. 17A is a top view but it is shown with hatching, for easy understanding.

Blue light from semiconductor laser 5 as a light source is made into parallel light by collimator lens array 6, and is incident on dichroic mirror 7. P-polarized light that has passed through dichroic mirror 7 is converted into circularly-polarized light by quarter wave plate 8, and collected to phosphor substrate 11 by condenser lenses 9. Phosphor substrate 11 includes substrate part 2, metal film 10a, red phosphor substance layer 3a, and green phosphor substance layer 3b. In the center of phosphor substrate 11, rotor 4 is placed. Phosphor substrate 11 is rotated around rotor 4 as the center.

A surface of substrate part 2 of phosphor substrate 11 is coated with metal film 10a. Substrate part 2 is formed of glass or metal. Red phosphor substance layer 3a coated with a red phosphor substance and green phosphor substance layer 3b coated with a green phosphor substance are formed on a part of metal film 10a. A region on which red phosphor substance layer 3a and green phosphor substance layer 3b are formed is defined as phosphor region 3.

Furthermore, a region on the surface of substrate part 2, which is coated with metal film 10a and which is not coated with red phosphor substance layer 3a and green phosphor substance layer 3b, is defined as reflection region 10. Thus, substrate part 2 includes phosphor region 3 and reflection region 10.

Green or red light emitted as fluorescence in phosphor region 3 of substrate part 2 is output from phosphor substrate 11 and reflected by dichroic mirror 7.

On the other hand, blue light reflected by reflection region 10 of substrate part 2 changes its polarization direction at quarter wave plate 8, and is reflected by dichroic mirror 7. The green or red light from phosphor region 3 and the blue light from reflection region 10 are synthesized by dichroic mirror 7 and output as white light.

Furthermore, for enhancing color purity of the green and red fluorescence emitted from excitation light from semiconductor laser 5, a light source device provided with a second wheel (not shown) having a dichroic filter is known.

Note here that prior art literatures relating to the present application, for example, Japanese Patent Application Unexamined Publication No. 2012-108486, and Japanese Patent Application Unexamined Publication No. 2012-212129 are known.

### SUMMARY

A light source device includes a light source and a phosphor substrate. The phosphor substrate includes a substrate part, a first reflection film, a phosphor substance layer, and a second reflection film. The first reflection film is formed on a first place of the substrate part. The phosphor substance layer is formed on a surface opposite to the substrate part of the first reflection film, and emits fluorescence by light from the light source. The second reflection film is formed on a second place of the substrate part, and reflects the light from the light source. A surface of the phosphor substance layer on which the light from the light source is incident and a surface of the second reflection film from which the light from the light source is reflected are in substantially the same plane.

### BRIEF DESCRIPTION OF DRAWINGS

FIG. 1 is a configuration diagram of a light source device in accordance with a first embodiment.

FIG. 2 is a graph showing spectral characteristics of a dichroic mirror of the light source device in accordance with the first embodiment.

FIG. 3A is a top view of a phosphor substrate of the light source device in accordance with the first embodiment.

FIG. 3B is a sectional view taken on line 3B-3B of FIG. 3A.

FIG. 4 is a graph showing light collection efficiency of the phosphor substrate of the light source device in accordance with the first embodiment.

FIG. 5 is a spectrum graph of a green phosphor substance layer of the phosphor substrate of the light source device in accordance with the first embodiment.

FIG. 6A is a sectional view showing a method for manufacturing the phosphor substrate of the light source device in accordance with the first embodiment.

FIG. 6B is a sectional view showing the method for manufacturing the phosphor substrate of the light source device in accordance with the first embodiment.

FIG. 6C is a sectional view showing the method for manufacturing the phosphor substrate of the light source device in accordance with the first embodiment.

FIG. 7A is a sectional view showing another method for manufacturing the phosphor substrate of the light source device in accordance with the first embodiment.

FIG. 7B is a sectional view showing another method for manufacturing the phosphor substrate of the light source device in accordance with the first embodiment.

FIG. 7C is a sectional view showing another method for manufacturing the phosphor substrate of the light source device in accordance with the first embodiment.

FIG. 7D is a sectional view showing another method for manufacturing the phosphor substrate of the light source device in accordance with the first embodiment.

FIG. 8A is a sectional view showing still another method for manufacturing the phosphor substrate of the light source device in accordance with the first embodiment.

FIG. 8B is a sectional view showing still another method for manufacturing the phosphor substrate of the light source device in accordance with the first embodiment.

FIG. 8C is a sectional view showing still another method for manufacturing the phosphor substrate of the light source device in accordance with the first embodiment.

FIG. 8D is a sectional view showing still another method for manufacturing the phosphor substrate of the light source device in accordance with the first embodiment.

FIG. 9A is a top view of another phosphor substrate of the light source device in accordance with the first embodiment.

FIG. 9B is a sectional view taken on line 9B-9B of FIG. 9A.

FIG. 10 is a configuration diagram of a light source device in accordance with a second embodiment.

FIG. 11 is a top view of an optical wheel substrate of the light source device in accordance with the second embodiment.

FIG. 12 is a configuration diagram of a light source device in accordance with a third embodiment.

FIG. 13 is a configuration diagram of a projection display device in accordance with a fourth embodiment.

FIG. 14 is a configuration diagram of a projection display device in accordance with a fifth embodiment.

FIG. 15 is a configuration diagram of a projection display device in accordance with a sixth embodiment.

FIG. 16 is a configuration diagram of a conventional light source device.

FIG. 17A is a top view of a conventional phosphor substrate.

FIG. 17B is a sectional view taken on line 17B-17B of FIG. 17A.

### DETAILED DESCRIPTION

In a conventional configuration, a distance of an optical path reaching phosphor region 3 from semiconductor laser 5 and a distance of an optical path reaching reflection region 10 from semiconductor laser 5 are different from each other. That is to say, a back focus from condenser lens 9 to a phosphor surface of phosphor region 3 is different from that to a mirror surface of reflection region 10. Therefore, light collection efficiency of fluorescence in phosphor region 3 and that of reflected light in reflection region 10 are different from each other, so that the light collection efficiency of each colored-light cannot be optimized. That is to say, the light collection efficiency of green and red light is different from the light collection efficiency of blue light, which may cause inconsistencies in brightness.

Furthermore, green and red light (fluorescence) emitted as fluorescence and blue light reflected by reflection region 10 are converted into substantially parallel light fluxes by condenser lens 9. However, since the uniformity of a light flux is different between the phosphor light and the reflected light, even when an integrator illuminating optical system is used, inconsistencies in colors may occur in a synthesized projected image of the green and red light emitted as fluorescence and the blue light mirror reflected. As a result, quality as the projection display device may not be satisfactory.

Hereinafter, embodiments are described in detail, appropriately with reference to drawings. However, unnecessarily detailed description may be omitted. For example, description of already well known matters or substantially the same configurations may not be repeated. This is because of avoiding the below-mentioned description becoming unnecessarily redundant for easy understanding by a person skilled in the art.

Note here that the attached drawings and the below-mentioned description are provided in order to allow a person skilled in the art to sufficiently understand the present disclosure, but these should not be construed to limit the subject matter described in claims.

### First Embodiment

### 1-1. Configuration

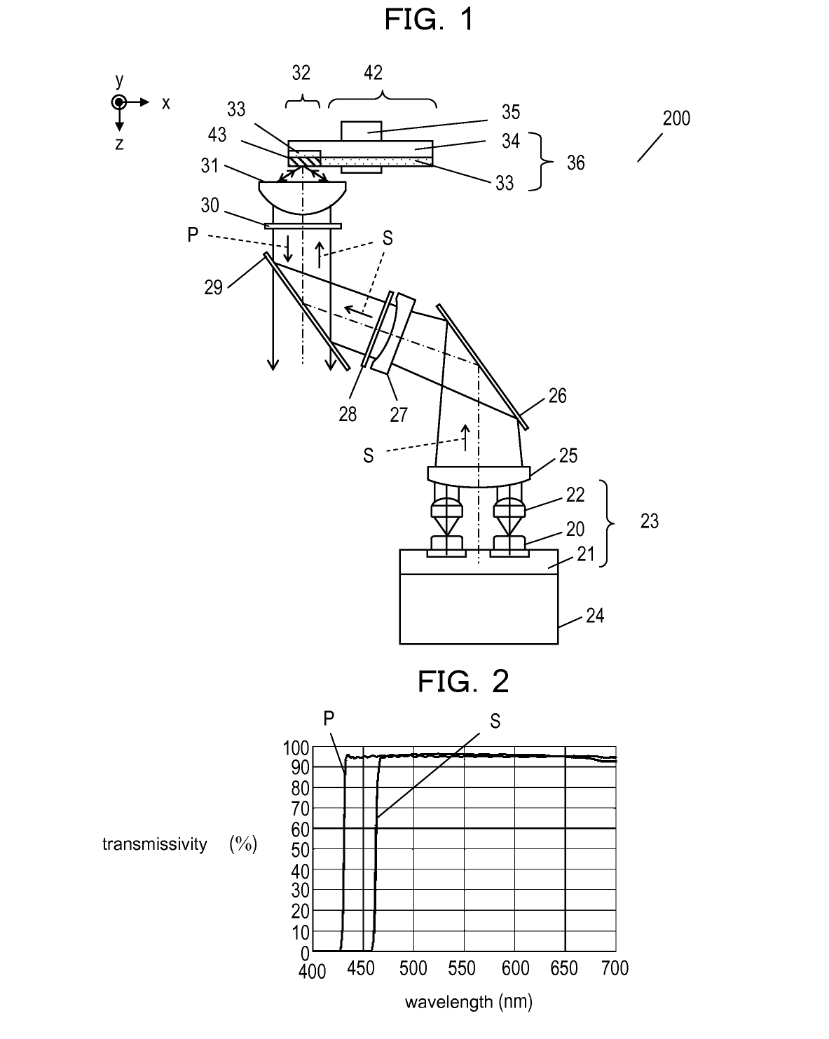

FIG. 1 is a configuration diagram of light source device 200 in accordance with a first embodiment.

Hereinafter, a configuration of light source device 200 is described in detail. Light source device 200 includes light source 20 and phosphor substrate 36. Furthermore, light source device 200 may include heat radiating plate 21, light-condensing lens 22, heat sink 24, lens 25, mirror 26, concave lens 27, and diffusion plate 28. Furthermore, light source device 200 may include dichroic mirror 29, quarter wave plate 30 as a phase difference plate, and condenser lens 31. Light source 20, heat radiating plate 21, and light-condensing lens 22 constitute light source unit 23. As light source 20, a semiconductor laser is used. However, light source 20 is not necessarily limited to the semiconductor laser, but a light emitting diode, organic EL (organic electroluminescence), or the like, may be used.

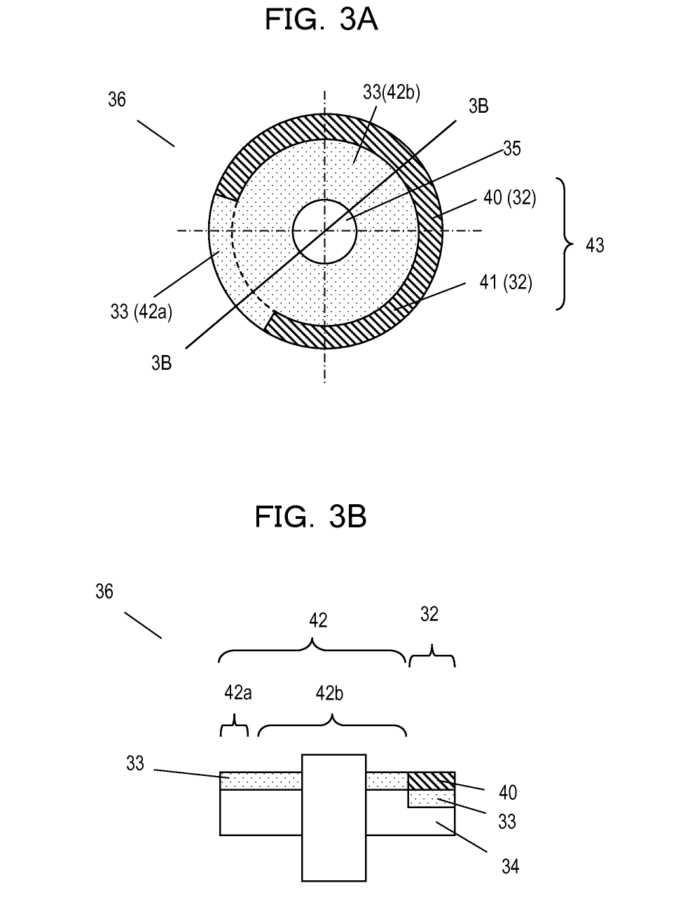

Phosphor substrate 36 includes substrate part 34, reflection film 33, and phosphor substance layer 43. Reflection film 33 is formed on substrate part 34. Phosphor substance layer 43 is formed in a part of reflection film 33. Phosphor substance layer 43 includes green phosphor substance layer 40 coated with a green phosphor substance and red phosphor substance layer 41 coated with a red phosphor substance (see FIGS. 3A and 3B). A region in which phosphor substance layer 43 is formed is defined as phosphor region 32. A region in which phosphor substance layer 43 is not formed is defined as reflection region 42. Rotor 35 is placed at the center of phosphor substrate 36. Phosphor substrate 36 is rotated around rotor 35 as a center. In FIG. 1, phosphor substrate 36 of FIG. 3B is placed upside down.

Substrate part 34 is formed of aluminum having high heat conductivity. Furthermore, substrate part 34 is rotated so as to suppress temperature increase of phosphor region 32 due to irradiation with light, and, thus, stable fluorescence conversion efficiency can be obtained. However, material of substrate part 34 is not necessarily limited to aluminum, and the material may be other metal.

As light source 20, eight (two columns and four rows) semiconductor lasers are disposed two-dimensionally at constant intervals on heat radiating plate 21. Then, light-condensing lens 22 is disposed corresponding to each semiconductor laser. Heat sink 24 is used for cooling light source unit 23.

The semiconductor laser outputs linearly polarized blue light in the wavelength width from 440 nm to 455 nm. The semiconductor laser is disposed such that the polarized light output from the semiconductor laser becomes S-polarized light when the polarized light is incident on dichroic mirror 29.

In FIG. 1, the S-polarized light is denoted by S, and the P-polarized light is denoted by P. The S-polarized light has a vibration direction vertical to a paper surface, and the P-polarized light has a vibration direction horizontal to the paper surface. That is to say, in the x, y, and z directions in FIG. 1, the S-polarized light vibrates in the y-direction, and the P-polarized light vibrates in the x-direction.

### 1-2. Operation

An operation of light source device 200 configured as mentioned above is described below.

Linearly polarized blue light output from a semiconductor laser is collected by corresponding light-condensing lens 22, and converted into parallel light fluxes. Thereafter, the light fluxes are incident on convex lens 25. The optical path of each of the light fluxes is folded by mirror 26. Then, the light fluxes are formed into substantially parallel light fluxes whose diameter is reduced by concave lens 27, and are incident on diffusion plate 28.

Diffusion plate 28 is made of glass and has a surface with fine concavities and convexities. Light incident on diffusion plate 28 is diffused by the concavities and convexities. A diffusing angle of diffusion plate 28 is a small as about 3°, and the polarization property is maintained. Light diffused by diffusion plate 28 is incident on dichroic mirror 29 at an incident angle of 55°.

FIG. 2 is a graph showing spectral characteristics of dichroic mirror 29 of the light source device in accordance with the first embodiment. P denotes characteristics of the P-polarized light and S denotes characteristics of the S-polarized light. FIG. 2 shows transmissivity with respect to wavelength. Dichroic mirror 29 reflects the S-polarized light of semiconductor laser light in a wavelength of 440 to 455 nm with high reflectivity of 95% or more, and transmits 92% or more of the P-polarized light. Furthermore, the P-polarized and S-polarized green and red light show such high transmissivity of 92% or more, respectively. When a difference of the wavelength between the P-polarized light and the S-polarized light in which the transmissivity is 50% is defined as a wavelength separation width, the wavelength separation width is 31 nm.

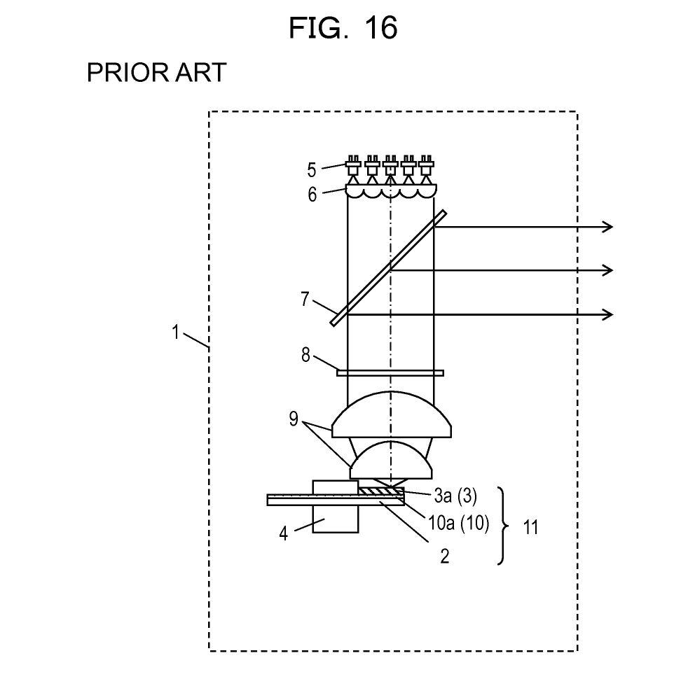

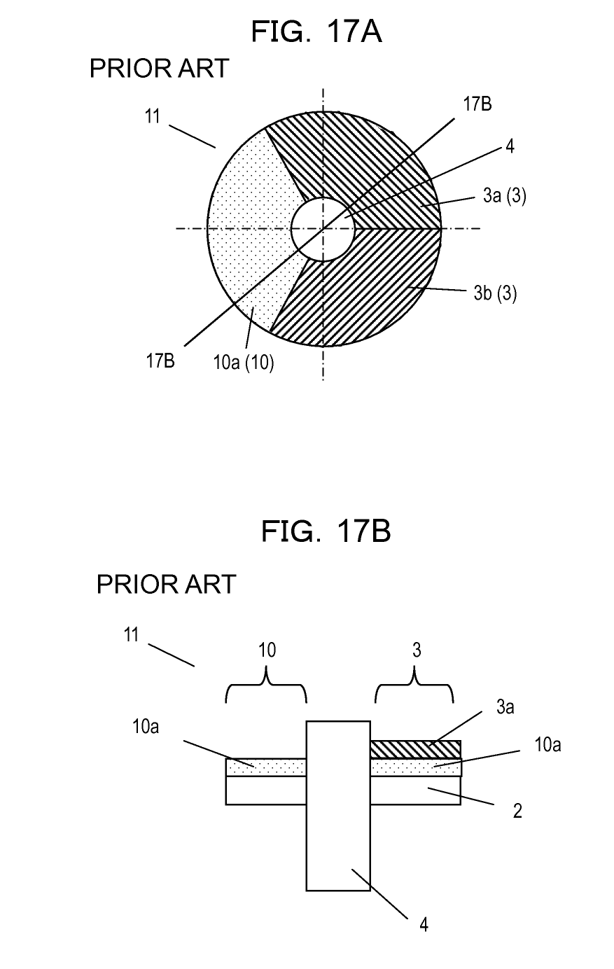

In conventional light source device 1 shown in FIG. 16, light is incident on the dichroic mirror at an incident angle of 45°. In this case, in general, the wavelength separation width between the P-polarized light and the S-polarized light is about 22 nm or less. Furthermore, the transmissivity of the P-polarized light at 440 nm is about 65%, and the reflectivity of the S-polarized light at 455 nm is about 70%. In the light emission wavelength band of the semiconductor laser, high transmissivity of the P-polarized light and high reflectivity of the S-polarized light cannot be obtained.

In this embodiment, light is incident on the dichroic mirror at an incident angle of 55°. Therefore, the dichroic mirror can reflect the S-polarized light from the semiconductor laser with high reflectivity, and can transmit the P-polarized light with high transmissivity. Herein, “the light is incident on the dichroic mirror at an incident angle of 55°” means that light is incident on the dichroic mirror at an incident angle of 55° with respect to the direction perpendicular to the dichroic mirror.

S-polarized blue light reflected by dichroic mirror 29 is incident on quarter wave plate 30 as the phase difference plate. Quarter wave plate 30 is a phase difference plate whose phase difference is ¼ wavelength in average light-emission wavelength of the semiconductor laser. Quarter wave plate 30 is formed of quartz having excellent heat resistance and durability. The S-polarized light incident on quarter wave plate 30 is converted into circularly-polarized light.

The light that has passed through quarter wave plate 30 is collected to light having a spot diameter of 1 mm or more and 2 mm or less by condenser lens 31, and is incident on phosphor substrate 36. Diffusion plate 28 diffuses light so that it has a desired spot diameter. Herein, a diameter of light whose light intensity is up to 13.5% with respect to the strongest peak intensity among the light intensity of the collected light is defined as a spot diameter.

FIG. 3A is a top view of phosphor substrate 36 of light source device 200 in accordance with the first embodiment. FIG. 3B is a sectional view taken on line 3B-3B of FIG. 3A. Circular phosphor substrate 36 (phosphor wheel) includes phosphor region 32 and reflection region 42.

Note here that FIG. 3A is a top view but it is shown with hatching, for easy understanding. Furthermore, in FIG. 3A, a surface of reflection film 33 formed in reflection region 42a and a surface of reflection film 33 formed in reflection region 42b are flush with each other, but they are shown to be differentiated from each other by a broken line in order to clearly show reflection region 42a.

In a part of substrate part 34 in which green phosphor substance layer 40 and red phosphor substance layer 41 are formed, a step height (recess portion) of about 0.2 mm is formed.

Then, reflection film 33 is formed on the surface of substrate part 34. On reflection film 33 of the step height part (recess portion) of substrate part 34, green phosphor substance layer 40 coated with a green phosphor substance or red phosphor substance layer 41 coated with a red phosphor substance is formed. Green phosphor substance layer 40 and red phosphor substance layer 41 form phosphor region 32. The thicknesses of green phosphor substance layer 40 and red phosphor substance layer 41 are respectively about 0.2 mm that is the same as the step height.

Furthermore, in substrate part 34, a region in which green phosphor substance layer 40 and red phosphor substance layer 41 are not formed is defined as reflection region 42. That is to say, on the surface of reflection region 42, reflection film 33 is exposed. In this way, phosphor substrate 36 has phosphor region 32 and reflection region 42. Reflection region 42 has reflection region 42a and reflection region 42b. Light is incident on phosphor region 32 and reflection region 42a.

That is to say, light source device 200 includes light source 20 and phosphor substrate 36. Phosphor substrate 36 includes substrate part 34, the first reflection film (reflection film 33), phosphor substance layer 43, and the second reflection film (reflection film 33). The first reflection film is formed in a first place (phosphor region 32) of substrate part 34. Phosphor substance layer 43 is formed on a surface opposite to substrate part 34 of the first reflection film, and emits fluorescence by light from light source 20. The second reflection film is formed in the second place (reflection region 42a) of substrate part 34, and reflects the light from light source 20. The surface of phosphor substance layer 43 on which the light from light source 20 is incident and the surface of the second reflection film from which the light from light source 20 is reflected are in substantially the same plane.

A position of the surface of substrate part 34 in the first place and a position of the surface of substrate part 34 in the second place are different from each other. Specifically, in a direction in which the first reflection film and phosphor substance layer 43 are laminated onto each other, the first place and the second place in substrate part 34 are different from each other by about 0.2 mm. In other words, a position of a surface of substrate part 34 with which the first reflection film is brought into contact and a position of a surface of substrate part 34 with which the second reflection film is brought into contact are different from each other.

In green phosphor substance layer 40, as a green phosphor substance emitting fluorescence containing a green component, Y3Al5O12:Ce3+ is used. In red phosphor substance layer 41, as a red phosphor substance emitting fluorescence containing a red component, CaAlSiN3:Eu2+ is used. As the reflection film of reflection region 42, a silver metal film is used.

In the direction orthogonal to an optical axis direction, a step height (recess) is formed in substrate part 34 in order to align a surface of green phosphor substance layer 40 or red phosphor substance layer 41 and a surface of reflection film 33 of the reflection region with each other.

Light incident on green phosphor substance layer 40 of phosphor substrate 36 emits fluorescence of colored light of a green component, and outputs it from phosphor substrate 36. Furthermore, light incident on red phosphor substance layer 41 emits fluorescence of colored light of a red component, and outputs it from phosphor substrate 36. Furthermore, the fluorescence emitted by green phosphor substance layer 40 and red phosphor substance layer 41 are reflected by reflection film 33, and output from phosphor substrate 36.

On the other hand, circularly-polarized blue light incident on reflection film 33 of reflection region 42a is reflected by reflection region 42a, becomes circularly-polarized light which counter-rotates relative to the incident circularly-polarized light, and is output from phosphor substrate 36. Reflection film 33 of reflection region 42 has surface accuracy in which polarization property is maintained.

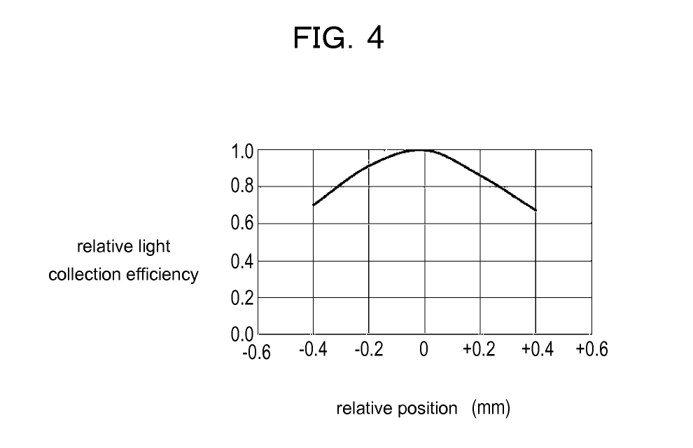

FIG. 4 is a graph showing light collection efficiency of phosphor substrate 36 of light source device 200 in accordance with the first embodiment. It shows relative light collection efficiency to a phosphor surface of phosphor substrate 36. In a relative position of the abscissa, a position of the phosphor surface of phosphor substrate 36 in which a position whose fluorescence has maximum light collection efficiency is 0. Condenser lens 31 has an F number of 0.53, and back focus of 1.6 mm. Since a position having the highest intensity of the fluorescence emission is a surface of phosphor substance layer 43, the surface of phosphor substance layer 43 may be thought to be a phosphor surface. As shown in FIG. 4, when the relative position is changed from 0 to +0.2 mm, the light collection efficiency is reduced by about 14%. When the relative position is changed from 0 to −0.2 mm, the light collection efficiency is reduced by about 10%. Herein, +0.2 mm means a state in which the phosphor surface approaches light source unit 23 by 0.2 mm from a position of the phosphor surface that shows the maximum light collection efficiency. Furthermore, −0.2 mm means a state in which the phosphor surface is apart by 0.2 mm from light source unit 23 from a position of the phosphor surface that shows the maximum light collection efficiency.

Therefore, when the surface (phosphor surface) of phosphor substance layer 43 and the surface (reflection surface) of reflection region 42 are displaced from each other by a thickness portion (about 0.2 mm) of phosphor substance layer 43, the light collection efficiency of the reflected light in reflection region 42 is reduced, so that the light collection efficiency cannot be optimized. Furthermore, the uniformity of the light flux of fluorescence collected by condenser lens 31 is different from the uniformity of the light flux of the reflected light, and thus, the synthesized light flux becomes nonuniform.

In this disclosure, there is no step height between the phosphor surface of phosphor substance layer 43 and the reflection surface of reflection region 42, and both surfaces are aligned with each other. Therefore, the light collection efficiency of the fluorescence and the light collection efficiency of the reflected light of the reflection region are optimized, respectively. Therefore, a light flux obtained by synthesizing the light flux of the fluorescence and blue light flux shows excellent uniformity.

It is preferable that the phosphor surface of phosphor region 32 and the reflection surface of reflection region 42 are aligned in the same plane, but variation in processing may occur. Thus, in order to suppress the reduction of the light collection efficiency to about 4% or less, it is preferable that the step height between the phosphor surface and the reflection surface is 0.1 mm or less. Furthermore, in order to suppress the reduction of the light collection efficiency to about 1% or less, it is preferable that the step height between the phosphor surface and the reflection surface is 0.05 mm or less.

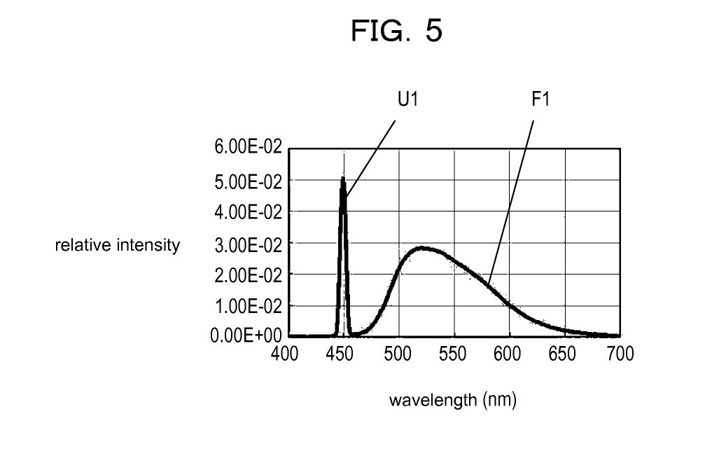

FIG. 5 is a spectrum graph of green phosphor substance layer 40 of phosphor substrate 36 of light source device 200 in accordance with the first embodiment. Fluorescence component F1 and unconverted component U1 are shown. Fluorescence component F1 is fluorescence emitted in green phosphor substance layer 40. Unconverted component U1 is unconverted fluorescence which does not emit fluorescence in green phosphor substance layer 40 and which is scattered and reflected by green phosphor substance layer 40 and reflection film 33. The unconverted fluorescence is relatively large as about 10% of the light incident on phosphor substrate 36. The unconverted fluorescence is reflected light that is multiplex-scattered by green phosphor substance layer 40. Therefore, polarization of the unconverted fluorescence is disturbed, and the polarization property at the time when the light is incident and output is not maintained. Light from red phosphor substance layer 41 similarly generates unconverted fluorescence. Measures against such unconverted fluorescence is described in a second embodiment.

Green and red fluorescence output from phosphor substrate 36 is collected by condenser lens 31, is converted into substantially parallel light, and then passes through quarter wave plate 30 and dichroic mirror 29. On the other hand, blue light reflected by reflection region 42 becomes circularly-polarized light which counter-rotates relative to the incident circularly-polarized light, is collected by the condenser lens, is converted into substantially parallel light, and then is converted into P-polarized light by quarter wave plate 30. Light that has been converted into the P-polarized light passes through the dichroic mirror. Light from phosphor region 32 and light from reflection region 42a, which have passed through the dichroic mirror, are synthesized into white light.

When green phosphor substance layer 40, red phosphor substance layer 41, and reflection region 42 are appropriately separated from each other based on values of the wavelength conversion efficiency from excitation light to green and red fluorescence, the intensity ratio of green, red, and blue light is adjusted, so that white light having an excellent white balance can be obtained.

Furthermore, the phosphor substrate may be divided into four regions, that is, a red phosphor substance layer, a green phosphor substance layer, a yellow phosphor substance layer, and a reflection region that is not coated with a phosphor substance. When the yellow phosphor substance layer is used, white light having further excellent white balance and high brightness can be obtained. As the yellow phosphor substance layer, for example, a Ce-activated YAG-system yellow phosphor substance layer is used.

Furthermore, in FIG. 1, one light source unit 23 is used, but a plurality of light source units may be used.

### 1-3. Advantage

As mentioned above, light source device 200 of this disclosure includes phosphor substrate 36 provided with a phosphor surface of phosphor substance layer 43 that emits fluorescence by a plurality of semiconductor lasers and reflection region 42 which reflects light. When the phosphor surface and the reflection surface are provided, fluorescence and reflected light are efficiently collected, and uniformity of the output light flux is improved.

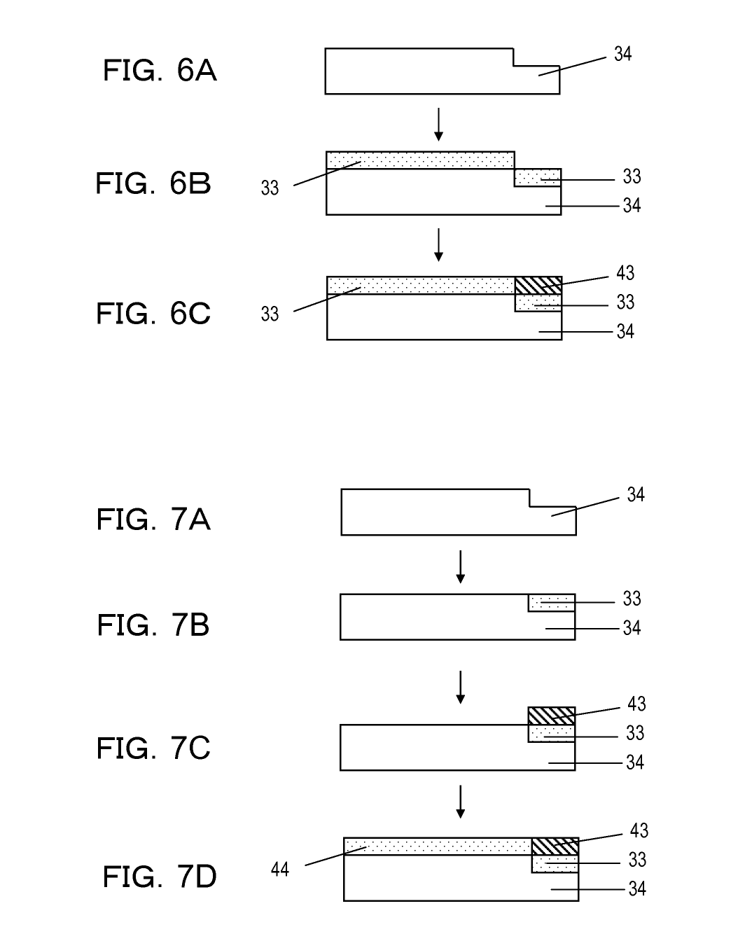

FIGS. 6A to 6C are sectional views showing a method for manufacturing phosphor substrate 36 of light source device 200 in accordance with the first embodiment. Phosphor substrate 36 is manufactured as shown in FIGS. 6A to 6C, sequentially.

As shown in FIG. 6A, a step height is formed in substrate part 34. Next, as shown in FIG. 6B, reflection film 33 is formed on the entire surface of substrate part 34. Furthermore, as shown in FIG. 6C, phosphor substance layer 43 is formed on reflection film 33 in a step height part.

That is to say, reflection film 33 (first reflection film) formed on phosphor region 32 and reflection film 33 (second reflection film) formed on reflection region 42a are formed of the same material by the same process. The surface (phosphor surface) of phosphor substance layer 43 and the surface (reflection surface) of reflection film 33 (second reflection film) are formed such that they are aligned in the same plane.

However, a method for manufacturing phosphor substrate 36 is not necessarily limited to the above-mentioned method. FIGS. 7A to 7D show sectional views showing another method for manufacturing phosphor substrate 36 of light source device 200 in accordance with the first embodiment.

As shown in FIG. 7A, a step height is formed in substrate part 34. Next, as shown in FIG. 7B, reflection film 33 is formed on the step height part. Furthermore, as shown in FIG. 7C, phosphor substance layer 43 is formed on reflection film 33 in the step height part. Next, as shown in FIG. 7D, reflection film 44 is formed in a place on which phosphor substance layer 43 is not formed. Herein, reflection film 33 (first reflection film) and reflection film 44 (second reflection film) may be formed of the same material or may be formed of different material. A surface (phosphor surface) of phosphor substance layer 43 and a surface (reflection surface) of reflection film 44 (second reflection film) are formed such that they are aligned in the same plane.

In this disclosure, reflection film 33 and phosphor substance layer 43 are formed in the step height part (recess portion) of substrate part 34. However, the configuration is not necessarily limited to this, and substrate part 34 may not be provided with the step height.

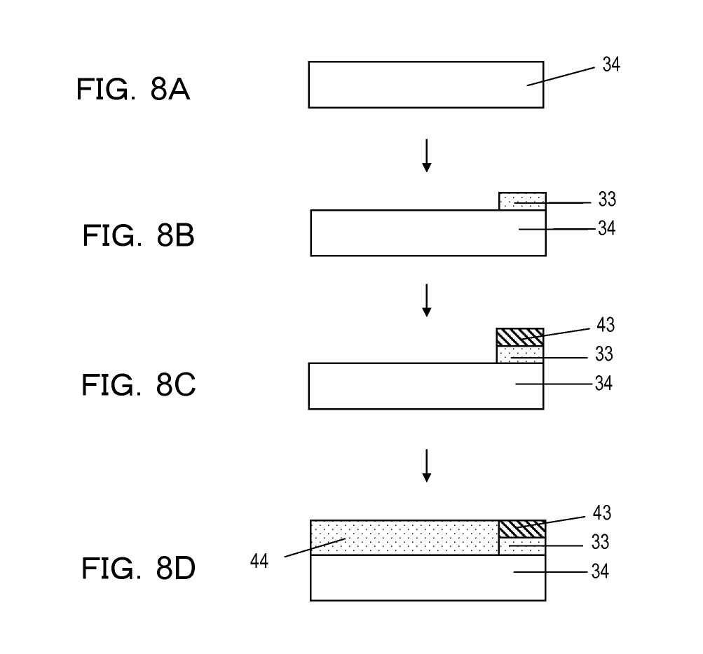

FIGS. 8A to 8D show sectional views showing still another method for manufacturing phosphor substrate 36 of light source device 200 in accordance with the first embodiment.

As shown in FIG. 8A, substrate part 34 is prepared. Next, as shown in FIG. 8B, reflection film 33 is formed on a part of substrate part 34. Furthermore, as shown in FIG. 8C, phosphor substance layer 43 is formed on reflection film 33. Next, as shown in FIG. 8D, reflection film 44 is formed in a place in which phosphor substance layer 43 is not formed. Herein, reflection film 33 and reflection film 44 may be formed of the same material or may be formed of different material. A surface (phosphor surface) of phosphor substance layer 43 and a surface (reflection surface) of reflection film 44 (second reflection film) are formed such that they are aligned in the same plane.

As mentioned above, reflection film 33 (first reflection film) formed in phosphor region 32 and reflection film 44 (second reflection film) formed in reflection region 42a may be formed of different material by different processes.

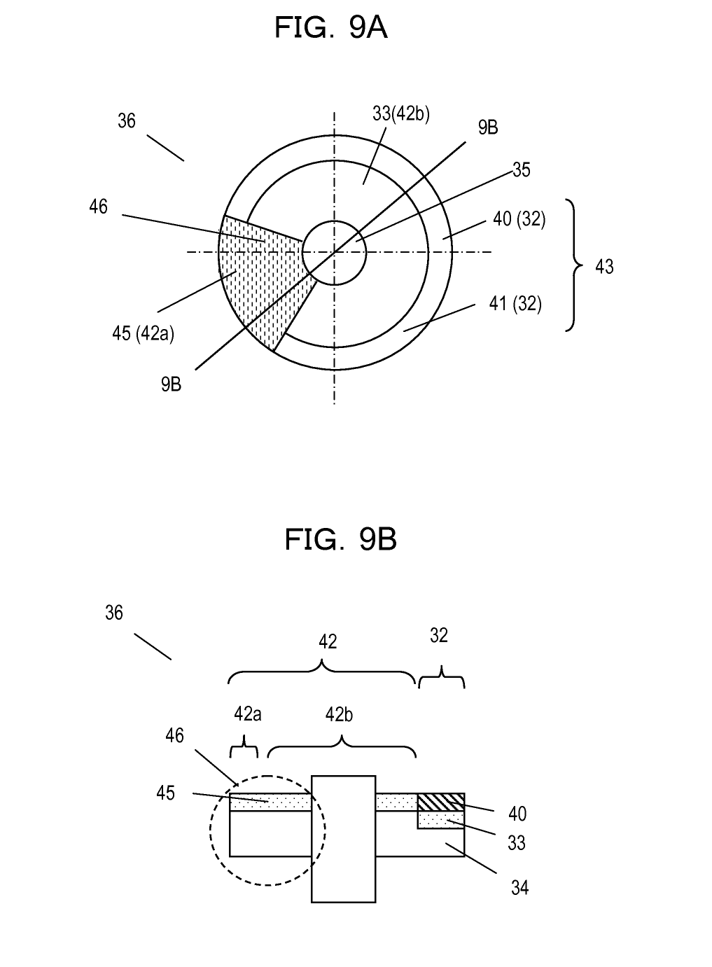

FIG. 9A is a top view of another phosphor substrate of light source device 200 in accordance with the first embodiment. FIG. 9B is a sectional view taken on line 9B-9B of FIG. 9A.

As shown in FIGS. 9A and 9B, phosphor region 32 in which phosphor substance layer 43 is formed, and fan-shaped region 46 in which phosphor substance layer 43 is not formed may be formed separately from each other, and thereafter, they may be bonded to each other. FIG. 9A is a top view, but only fan-shaped region 46 is shown with hatching for easy understanding. Reflection region 42a is included inside fan-shaped region 46. In this case, reflection film 33 in a region in which phosphor substance layer 43 is formed, and reflection film 45 in fan-shaped region 46 in which phosphor substance layer 43 is not formed may be formed of the same material or different material. Also in this case, the surface of phosphor substance layer 43 (phosphor surface) and a surface of reflection film 45 (second reflection film) are formed such that they are aligned in the same plane.

### Second Embodiment

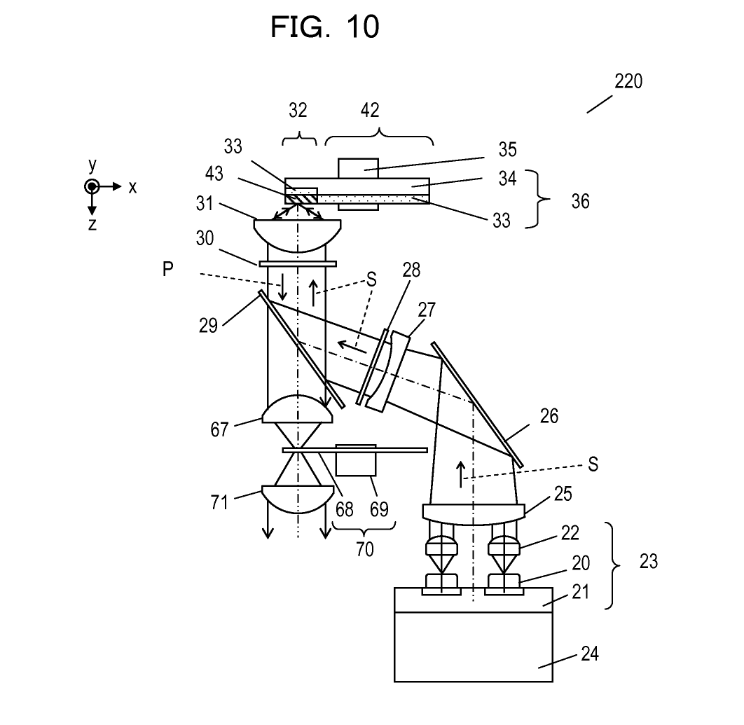

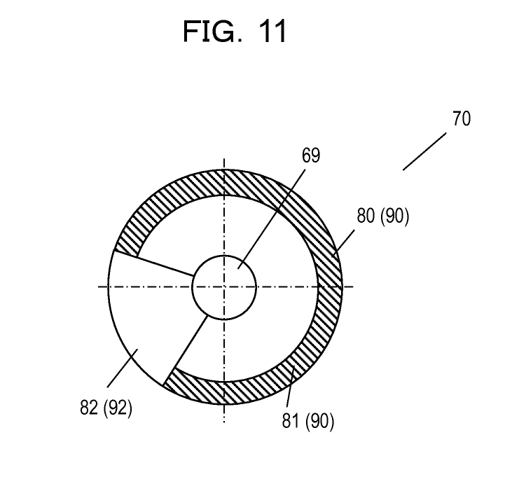

FIG. 10 is a configuration diagram of light source device 220 in accordance with a second embodiment. FIG. 11 is a top view of optical wheel substrate 70 of light source device 220 in accordance with the second embodiment. The second embodiment is different from the first embodiment in that condenser lenses 67 and 71 and optical wheel substrate 70 are provided. Optical wheel substrate 70 includes substrate part 68 and rotor 69. Substrate part 68 includes colored filter region 90 provided with a dichroic filter, and diffusion region 92. The other configuration is the same as in the first embodiment. The same reference numerals are given to the same configurations as those in the first embodiment and the description thereof is omitted.

An operation, in which light output from light source 20 is incident on phosphor substrate 36 and then light output from phosphor substrate 36 passes through dichroic mirror 29, is the same as in the first embodiment. Light that has passed through dichroic mirror 29 is collected by condenser lens 67, and incident on optical wheel substrate 70.

Condenser lens 67 is a lens having a focal length in which an incident angle of optical wheel substrate 70 to a dichroic filter is 35° or less. A size of a spot diameter of light collected to optical wheel substrate 70 is about 2.5 times as large as a spot diameter of light collected to phosphor substrate 36. Optical wheel substrate 70 includes substrate part 68 having colored filter region 90 provided with a dichroic filter and diffusion region 92, and rotor 69.

Circular-shaped optical wheel substrate 70 is divided into three filter regions 80, 81, and 82. Filter region 80 is provided with a dichroic filter which reflects unconverted fluorescence (see FIG. 5) and transmits a green component. Filter region 81 is provided with a dichroic filter which reflects unconverted fluorescence and transmits a red component. Filter region 80 and filter region 81 form colored filter region 90. Filter region 82 is diffusion region 92 for diffusing incident blue light. Filter region 82 is a diffusion plate made of glass, similar to diffusion plate 28, and has a diffusion angle of 10°±2°.

Filter region 80 corresponds to green phosphor substance layer 40 of phosphor substrate 36. Filter region 81 corresponds to red phosphor substance layer 41 of phosphor substrate 36. Filter region 82 corresponds to reflection region 42a of phosphor substrate 36. Then, optical wheel substrate 70 is rotated while filter region 80, filter region 81, and filter region 82 are synchronized with green phosphor substance layer 40, red phosphor substance layer 41, and reflection region 42, respectively, so as to transmit or diffuses specific light.

In optical wheel substrate 70, unconverted fluorescence in phosphor region 32, which has passed through dichroic mirror 29, is reflected by filter region 82, unnecessary blue light which is mixed with green and red light is sufficiently cut, and red color purity is improved. Furthermore, light reflected by the reflection surface of reflection region 42a of phosphor substrate 36 is diffused in filter region 82, and speckle of the diffused laser light is reduced, and thus the uniformity is improved.

In this embodiment, filter region 80 is provided with a dichroic filter which reflects the unconverted fluorescence and transmits a green component. Filter region 81 is provided with a dichroic filter which reflects the unconverted fluorescence and transmits a red component. However, filter regions 80 and 81 may be formed of only a dichroic filter which reflects the unconverted fluorescence. In this case, filter regions 80 and 81 may be formed of the same dichroic filter.

Light that has passed through optical wheel substrate 70 is converted into substantially parallel light by condenser lens 71 and output. The output light flux becomes white light having high color purity of green and red, excellent uniformity, and excellent white balance.

As mentioned above, the light source device of this disclosure includes phosphor substrate 36 and optical wheel substrate 70. Phosphor substrate 36 includes phosphor region 32 which emits fluorescence by light of a plurality of semiconductor lasers and reflection region 42a that reflects light. Optical wheel substrate 70 includes filter regions 80 and 81 (colored filter region 90) which reflects unconverted fluorescence that has not emitted fluorescence at phosphor region 32 of phosphor substrate 36 and transmits a specific color component, and filter region 82 (diffusion region 92) which diffuses light that has been reflected by reflection region 42a of phosphor substrate 36. With this configuration, a light source device having high color purity and high uniformity can be obtained.

### Third Embodiment

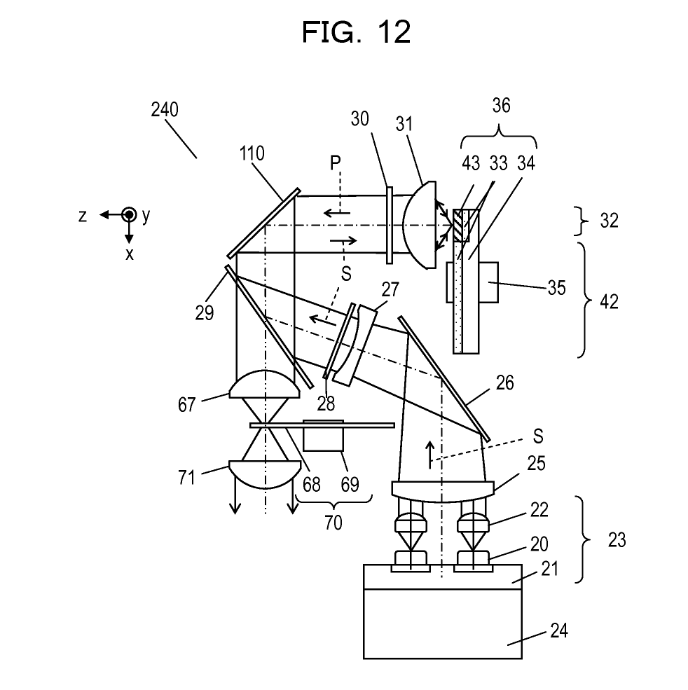

FIG. 12 is a configuration diagram of light source device 240 in accordance with a third embodiment. The third embodiment is different from the second embodiment in that folding mirror 110 is used and that phosphor substrate 36 and optical wheel substrate 70 are disposed orthogonal to each other. The other configuration is the same as in the second embodiment. With this configuration, light source device 240 can be reduced in size. Note here that the same reference numerals are given to the same configurations as those in the first and second embodiments, and the description thereof is omitted.

An operation in which light output from light source 20 is incident on dichroic mirror 29 is the same as in the first and second embodiments. S-polarized light output from diffusion plate 28 is reflected by dichroic mirror 29. An optical path of S-polarized blue light reflected by dichroic mirror 29 is folded by mirror 110, and then the blue light is incident on quarter wave plate 30. Quarter wave plate 30 is a phase difference plate having a phase difference of ¼ wavelength in an average light-emission wavelength of the semiconductor laser as light source 20. Quarter wave plate 30 is made of quartz. The incident light of the S-polarized light is converted into circularly-polarized light at quarter wave plate 30.

Light that has passed through quarter wave plate 30 is collected to phosphor substrate 36 by condenser lens 31. Phosphor substrate 36 includes substrate part 34, reflection film 33 formed on substrate part 34, and phosphor substance layer 43. In the center of phosphor substrate 36, rotor 35 is placed. Phosphor substrate 36 is rotated around rotor 35 as the center. Light incident on a phosphor region of phosphor substance layer 43 emits fluorescence of a green component and a red component, and is output from phosphor substrate 36.

Furthermore, light incident on reflection film 33 of the phosphor region is reflected by reflection film 33, and is output from phosphor substrate 36. On the other hand, circularly-polarized blue light incident on reflection film 33 is reflected by reflection region 42a, becomes circularly-polarized light which counter-rotates relative to the incident circularly-polarized light, and is output from phosphor substrate 36.

Green and red fluorescence output from phosphor substrate 36 is collected by condenser lens 31, is converted into substantially parallel light, then passes through quarter wave plate 30, is reflected by mirror 110, and passes through dichroic mirror 29.

On the other hand, the reflected blue light reflected by a reflection region maintains the polarization property, is collected by condenser lens 31, is converted into substantially parallel light, and then converted into P-polarized light at quarter wave plate 30. Light converted into the P-polarized light is reflected by mirror 110, and passes through dichroic mirror 29. The subsequent operations are the same as in the second embodiment.

As mentioned above, light source device 240 of this embodiment includes phosphor substrate 36 and optical wheel substrate 70. Phosphor substrate 36 includes a phosphor surface of phosphor region 32 which emits fluorescence by light from light source 20, and reflection region 42a which reflects light. Optical wheel substrate 70 includes filter regions 80 and 81 which reflect unconverted fluorescence that has not emitted fluorescence by phosphor region 32 of phosphor substrate 36 and which transmit a specific color component, and filter region 82 (diffusion region) which diffuses light reflected by reflection region 42a of phosphor substrate 36. Phosphor substrate 36 and optical wheel substrate 70 substantially orthogonal to each other.

With this configuration, light source device 240 can be reduced in size. That is to say, light source device 240 having a small size, high color purity, and high uniformity can be obtained.

### Fourth Embodiment

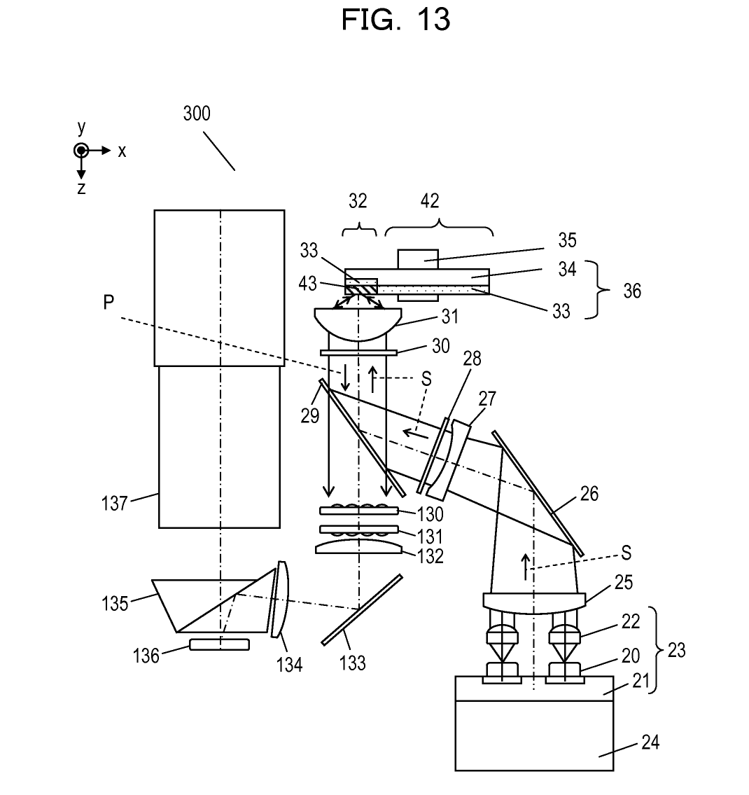

FIG. 13 is a configuration diagram of projection display device 300 in accordance with a fourth embodiment. Projection display device 300 of this embodiment includes light source device 200 of the first embodiment, an image-formation element, an illuminating optical system for illuminating the image-formation element, and projection lens 137 for enlarging and projecting an image formed by light in the image-formation element.

In this embodiment, as the image-formation element, one digital micro-mirror device (DMD) 136 is used. Furthermore, as the illuminating optical system, an integrator optical system including first lens array plate 130 and second lens array plate 131 is used.

An operation in which light output from light source 20 is incident on phosphor substrate 36 and then light output from phosphor substrate 36 passes through dichroic mirror 29 is the same as in the first embodiment. The same reference numerals are given to the same configurations as those in the first embodiment and the description thereof is omitted.

The light incident on phosphor substrate 36 outputs red, green and blue light in time series manner by the rotation of phosphor substrate 36. The output red, green and blue light is incident on first lens array plate 130 including a plurality of lens elements. Light fluxes incident on first lens array plate 130 are divided into a large number of light fluxes. The large number of divided light fluxes converge into second lens array plate 131 including a plurality of lenses.

A place which transmits the light of the lens element of first lens array plate 130 is geometrically similar to the shape of DMD 136. The lens element of second lens array plate 131 has a predetermined focal length such that first lens array plate 130 and DMD 136 have substantially conjugate relation. The light output from second lens array plate 131 is incident on superimposing lens 132. Superimposing lens 132 is a lens for illuminating DMD 136 in a superimposed manner with the light output from each lens element of second lens array plate 131.

The light from superimposing lens 132 is reflected by mirror 133, and then incident on field lens 134. Light output from field lens 134 is totally reflected by total reflection prism 135, and then incident on DMD 136. Total reflection prism 135 includes two prisms and an air layer interposed between the two prisms. Then, the air layer totally reflects light incident at an angle of a critical angle or more. Therefore, the light from field lens 134 is totally reflected, and illuminates DMD 136. Furthermore, light output from the DMD passes through total reflection prism 135.

Light incident on DMD 136 deflects only light fluxes necessary for image formation according to an image signal, passes through total reflection prism 135, and then is incident on projection lens 137. Projection lens 137 enlarges and projects an image light modulated and formed at DMD 136. As mentioned above, in this embodiment, since one DMD is used and light source device 200 of the first embodiment is used as the light source device, projection display device 300 having a small size, high brightness, and long lifetime can be obtained.

In this embodiment, as an integrator optical system for securing the uniformity of the projected image, first lens array plate 130 and second lens array plate 131 are used, but a rod integrator may be used.

As mentioned above, projection display device 300 of this embodiment includes light source device 200, an integrator illuminating optical system using a lens array, and one DMD 136. Light source device 200 includes phosphor substrate 36. Phosphor substrate 36 includes phosphor region 32 that emits fluorescence from light source 20, and reflection region 42a that reflects the light. A phosphor surface of phosphor region 32 of phosphor substrate 36 and a reflection surface of reflection region 42a are aligned with each other.

According to this embodiment, projection display device 300 having a small size and high uniformity of projected images and capable of bright display is obtained.

### Fifth Embodiment

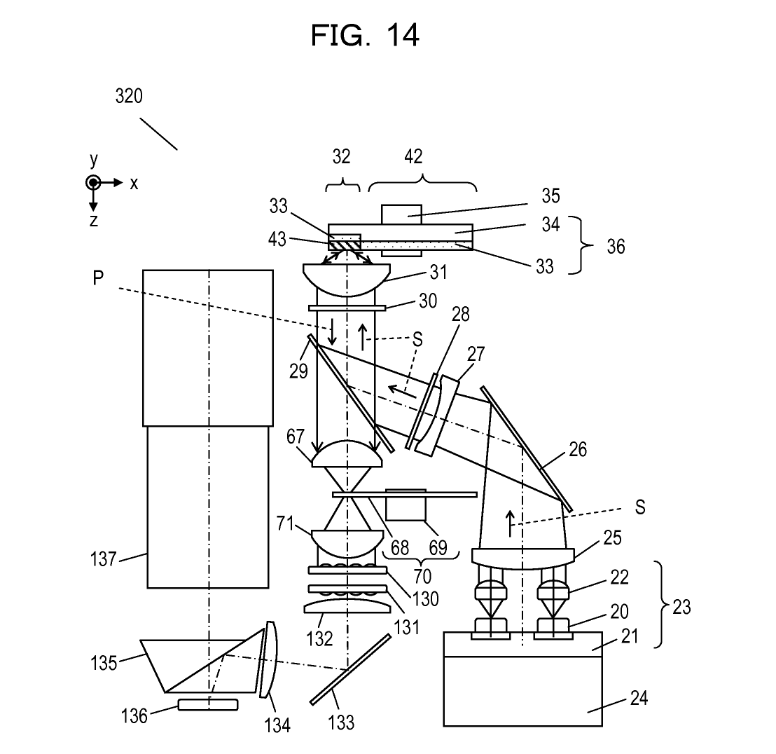

FIG. 14 is a configuration diagram of projection display device 320 in accordance with a fifth embodiment. Projection display device 320 in accordance with this embodiment includes light source device 220 of the second embodiment, an image-formation element, an illuminating optical system for illuminating the image-formation element, and projection lens 137 for enlarging and projecting an image by light formed by the image-formation element.

In this embodiment, as an image-formation element, one digital micro-mirror device (DMD) 136 is used. Furthermore, as an illuminating optical system, an integrator optical system including first lens array plate 130 and second lens array plate 131 is used.

An operation, in which light output from light source 20 is incident on phosphor substrate 36, then light output from phosphor substrate 36 passes through optical wheel substrate 70 and is converted into substantially parallel light by condenser lens 71 and output, is the same as in the second embodiment.

Furthermore, an operation, in which DMD 136 is irradiated with light output from condenser lens 71 and the light is incident on projection lens 137, is the same as in the fourth embodiment. The same numerals are given to the same configuration as in the second and fourth embodiments, and description thereof is omitted.

In this embodiment, since one DMD 136 is used, and light source device 220 of the second embodiment is used as the light source device, a projection display device having a small size, high brightness, and long lifetime is obtained.

Furthermore, in this embodiment, as an integrator optical system for securing the uniformity of the projected image, first lens array plate 130 and second lens array plate 131 are used, but a rod integrator may be used.

As mentioned above, projection display device 320 of this embodiment includes light source device 220, an integrator illuminating optical system using a lens array, and one DMD 136. Light source device 220 includes phosphor substrate 36 and optical wheel substrate 70. Phosphor substrate 36 includes phosphor region 32 emitting fluorescence by light from light source 20, and reflection region 42a for reflecting light. A phosphor surface of phosphor region 32 of phosphor substrate 36 and a reflection surface of reflection region 42a are aligned with each other. This configuration permits projection display having high color purity of green and red, a small size, high uniformity, and high brightness.

### Sixth Embodiment

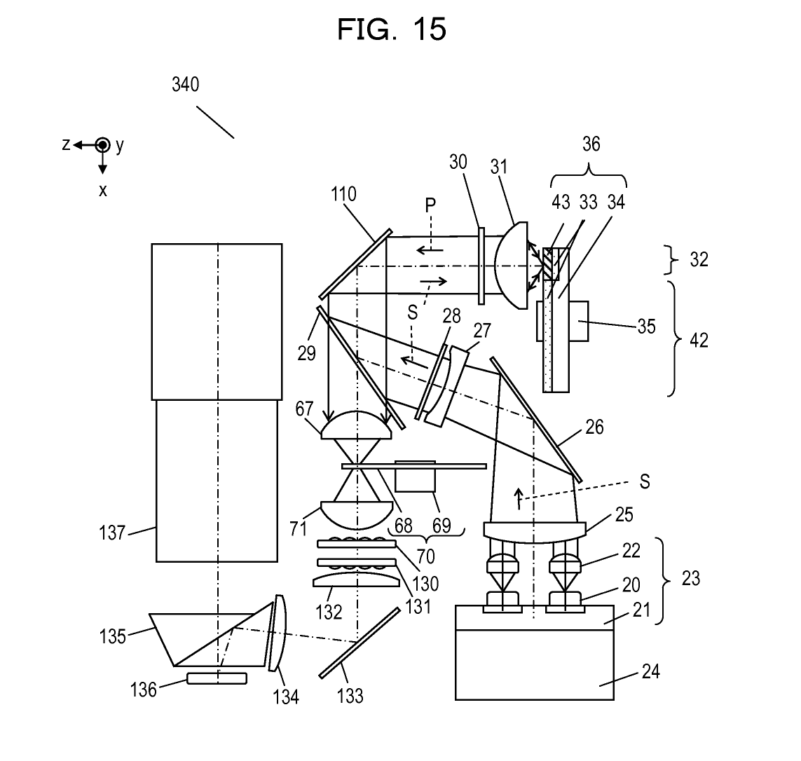

FIG. 15 is a configuration diagram of projection display device 340 in accordance with a sixth embodiment. Projection display device 340 in accordance with this embodiment includes light source device 240 of the third embodiment, an image-formation element, an illuminating optical system for illuminating the image-formation element, and projection lens 137 for enlarging and projecting an image with light formed in the image-formation element.

As the image-formation element, one digital micro-mirror device (DMD) 136 is used. Furthermore, as the illuminating optical system, an integrator optical system including first lens array plate 130 and second lens array plate 131 is used.

An operation in which, light output from light source 20 is incident on phosphor substrate 36, then light output from phosphor substrate 36 passes through optical wheel substrate 70, and is converted into substantially parallel light by condenser lens 71 and output, is the same as in the third embodiment.

Furthermore, an operation in which the DMD is irradiated with light output from condenser lens 71, and the light is incident on projection lens 137 is the same as in the fourth embodiment. The same numerals are given to the same configurations as in the third and fourth embodiments, and description thereof is omitted.

According to this embodiment, since one DMD 136 is used, and light source device 240 of the third embodiment is used for the light source device, a projection display device having a compact size, high brightness, and long lifetime can be obtained.

Furthermore, in this embodiment, as an integrator optical system for securing the uniformity of the projected image, first lens array plate 130 and second lens array plate 131 are used, but a rod integrator may be used.

As mentioned above, projection display device 340 of this embodiment includes light source device 240, an integrator illuminating optical system using a lens array, and one DMD 136. Light source device 240 includes phosphor substrate 36 and optical wheel substrate 70. Phosphor substrate 36 includes phosphor region 32 emitting fluorescence with light from light source 20, and reflection region 42a for reflecting light. A position of a surface of phosphor substance of phosphor region 32 of phosphor substrate 36 and a position of a reflection surface of reflection region 42a are aligned with each other.

With this configuration, a projection display having a compact size, high color purity of green and red, high uniformity, and high brightness can be obtained.

With this disclosure, a light source device having improved light collection efficiency, improved uniformity of light fluxes, an excellent color reproduction range can be obtained. Therefore, a projection display device having high brightness and excellent quality can be obtained.

The present disclosure can be applied for a light source device and a projection display device capable of irradiating an image formed by a light valve with light from the light source device, and enlarging and projecting the image on a screen by a projection lens.

What is claimed is:

1. A light source device comprising:
a light source;
a phosphor substrate including:
a substrate part;
a first reflection film formed on a first place of the substrate part;
a phosphor substance layer formed on a surface opposite to the substrate part of the first reflection film, and emitting fluorescence by light from the light source; and
a second reflection film formed on a second place of the substrate part and reflecting the light from the light source,
wherein a surface of the phosphor substance layer on which the light from the light source is incident and a surface of the second reflection film from which the light from the light source is reflected are in substantially a same plane.

2. The light source device of claim 1, wherein a step height between the surface of the phosphor substance layer and the surface of the second reflection film is not more than 0.1 mm.

3. The light source device of claim 1, wherein a position of a surface of the substrate part in the first place and a position of a surface of the substrate part in the second place are different from each other.

4. The light source device of claim 1, wherein the phosphor substance layer includes a green phosphor substance layer and a red phosphor substance layer.

5. The light source device of claim 1, wherein the first reflection film and the second reflection film are formed of same material.

6. The light source device of claim 1, wherein the first reflection film and the second reflection film are formed of different material from each other.

7. The light source device of claim 1, further comprising:
an optical wheel substrate including:
a filter region which transmits a specific color component of light output from the phosphor substance layer, and
a diffusion region which diffuses light reflected by the second reflection film.

8. The light source device of claim 7, wherein the phosphor substrate and the optical wheel substrate are disposed substantially orthogonal to each other.

9. The light source device of claim 1, wherein the light source is capable of emitting semiconductor laser light in blue.

10. The light source device of claim 1, wherein the light source is capable of emitting linearly polarized light.

11. The light source device of claim 1, further comprising a dichroic mirror placed between the light source and the phosphor substrate,
wherein the dichroic mirror is disposed such that the light from the light source is incident at an incident angle of 55°.

12. The light source device of claim 1, wherein the phosphor substrate is a rotatable circular substrate.

13. A projection display device comprising:
the light source device according to claim 1;
an image-formation element forming an image;
an illuminating optical system for collecting light from the light source device and illuminating the image-formation element; and
a projection lens for enlarging and projecting an image by light, which is formed by the image-formation element.

14. The projection display device of claim 13, wherein the image-formation element is a digital micro-mirror device.
